(19) United States
(12) Patent Application Publication
(10) Pub. No.: US 2025/0229695 A1
(43) Pub. Date: Jul. 17, 2025

(54) ELECTRIC RETRIEVAL ROBOT AND/OR TRAILER

(71) Applicant: Howe & Howe Inc., Waterboro, ME (US)

(72) Inventors: Timothy Merlin Foley, Lyman, ME (US); Matthew Gregory Williams, Kennebunk, ME (US)

(21) Appl. No.: 19/022,457

(22) Filed: Jan. 15, 2025

Related U.S. Application Data
(60) Provisional application No. 63/621,433, filed on Jan. 16, 2024.

(51) Int. Cl. B60P 1/54; A62C 27/00; B62D 33/02; B62D 55/08

(52) U.S. Cl. CPC B60P 1/5428; A62C 27/00; B62D 33/02; B62D 55/08

(57) ABSTRACT

A technique is directed to a vehicle assembly. The vehicle assembly includes a vehicle body having a top deck. The vehicle assembly further includes a basket affixed to the top deck. The vehicle assembly still further includes a crane coupled to the vehicle body. The crane is constructed and arranged to lift a hazardous object and place the hazardous object into the basket.

### CROSS-REFERENCE TO RELATED APPLICATIONS

This application claims the benefit of U.S. Provisional Patent Application No. 63/621,433, filed Jan. 16, 2024, the contents and teachings of which are incorporated herein by reference in their entirety.

### BACKGROUND

### 1. Field

This disclosure relates generally to vehicle designs, and more particularly to remote-controlled, electric tracked vehicles and trailers for use in transporting hazardous cargo.

### 2. Description of Related Art

Firefighting vehicles include firetrucks and firefighting robots. Firefighting robots are specially adapted for spraying water on fires. Smaller than firetrucks, firefighting robots are maneuverable, remote-controlled vehicles that are able to aim water accurately at desired targets. For example, the Thermite robot available from Howe & Howe, Inc. of Waterboro, ME, is a remote controlled, tracked vehicle with a remotely aimed nozzle (monitor) that can discharge 1,500 gallons or more of water per minute. The Thermite has the ability to withstand environments that are too hazardous for human personnel.

### SUMMARY

Some situations call for fire resistance but not necessarily firefighting. For example, factory floors, warehouses, and other facilities may store lithium-ion batteries or other flammable items. In the event that these items catch fire or are at risk of catching fire, operators of these facilities may wish to transport the items to a safe location, away from other stock, personnel, and equipment, such that fire can be extinguished, prevented, or allowed to burn itself out in a manner that does not present a hazard.

Unfortunately, conventional forklifts and carts commonly found in facilities are not well suited for transporting items that are on fire. They are also not capable of easily picking up burning items and placing them in a manner that allows for their safe transport. Accordingly, there is a need for vehicles capable of picking up burning or other hazardous items and transporting them to safety.

The above need is addressed at least in part by a vehicle assembly that can be operated by remote control. The vehicle assembly includes a top deck and a crane capable of grasping and lifting burning items and placing them onto the top deck. Items placed in this manner can be driven by remote control to a safe location.

Certain embodiments are directed to a vehicle assembly. The vehicle assembly includes a vehicle body having a top deck. The vehicle assembly further includes a basket affixed to the top deck. The vehicle assembly still further includes a crane coupled to the vehicle body. The crane is constructed and arranged to lift a hazardous object and place the hazardous object into the basket.

Other embodiments are directed to a remote-controlled firefighting vehicle. The firefighting vehicle includes a vehicle body having a top deck. The firefighting vehicle further includes a basket affixed to the top deck. The firefighting vehicle still further includes a crane coupled to the vehicle body at a first end of the vehicle body, the crane constructed and arranged to lift a hazardous object and place the hazardous object into the basket. The firefighting vehicle still further includes first and second outriggers coupled to the first end, the first and second outriggers constructed and arranged to resist lifting of a second end of the vehicle body. The firefighting vehicle still further includes control circuitry constructed and arranged to drive the firefighting vehicle, operate the first and second outriggers, and operate the crane based on control commands received from a remote controller.

Still other embodiments are directed to a method of operating a vehicle assembly, such as the vehicle assembly described above. The method includes, based on receiving a first set of control commands from a remote controller, driving the vehicle assembly to a location of a hazardous object. The vehicle assembly includes (i) a vehicle body having a top deck and (ii) a basket being affixed to the top deck. The method further includes, based on receiving a second set of control commands from the remote controller, operating a crane coupled to the vehicle body to lift the hazardous object and place the hazardous object into the basket. The method still further includes, based on receiving a third set of control commands from the remote controller, driving the vehicle assembly to transport the hazardous object.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is an upper-left, front isometric view of an example vehicle according to one or more embodiments.

FIG. 2 is a left elevated view of another example vehicle, according to one or more embodiments.

FIG. 3 is a front elevated view thereof.

FIG. 4 is an upper-left isometric view of a vehicle configuration according to one or more embodiments.

FIG. 5 is a left elevated view thereof.

FIG. 6 is a front elevated view thereof.

FIG. 7 is a rear elevated view thereof.

FIG. 8 is a top view thereof.

FIG. 9 is an upper-left, rear isometric view thereof.

FIG. 10 is an upper-left, rear isometric view of an example trailer in accordance with one or more embodiments.

FIG. 11 is an upper-rear, isometric view of an example firefighting vehicle which may be used to tow the trailer of FIG. 10.

FIG. 12 is a block diagram of an example remote-control arrangement for controlling the vehicle of FIG. 1, the trailer of FIG. 10, and/or a combination of the firefighting vehicle of FIG. 11 and the trailer of FIG. 10.

### DETAILED DESCRIPTION

Embodiments of the improved technique will now be described. One should appreciate that such embodiments are provided by way of example to illustrate certain features and principles but are not intended to be limiting.

According to one or more embodiments, an improved technique for transporting hazardous materials includes a vehicle assembly that can be operated by remote control. The vehicle assembly includes a body having a top deck and a crane capable of grasping and lifting burning or other hazardous items and placing them onto the top deck. Items placed in this manner can then be driven by remote control to a safe location.

According to one or more embodiments, the vehicle assembly includes a tracked vehicle having a body with a top deck, as described above. According to one or more further embodiments, the vehicle assembly includes a trailer having a body with a top deck, as described above. According to one or more still further embodiments, the vehicle assembly includes both a tracked vehicle and a trailer towed by a tracked vehicle. The trailer has a body with a top deck, as described above.

In some examples, once at the safe location, the crane may be operated to remove the hazardous item from the vehicle assembly, e.g., by placing the item onto the ground or into a container, where fire may be extinguished by water and/or foam, suffocated, or allowed to burn itself out.

In some examples, the vehicle assembly includes a basket mounted to the top deck for receiving hazardous items.

In some examples, the basket includes a bottom with side members extending upwardly therefrom. The side members are constructed and arranged to prevent hazardous items from sliding off the sides of the vehicle assembly.

In some examples, the side members are interchangeable with other side members having different lengths and/or shapes.

In some examples, the bottom of the basket includes multiple receivers that allow side members to be inserted, removed, or replaced.

In some examples, the side members are attached to the bottom at obtuse angles, such that the basket is wider on top than at the bottom.

In some examples, the bottom of the basket includes a frame attached to and spaced above the top deck. The frame includes axial and/or transverse members.

In some examples, the vehicle assembly includes a sealable compartment for receiving items. For example, a burning item may be placed into the compartment, which may be sealed to suffocate any flames or at least to contain the flames.

In some examples, the tracks of the vehicle assembly are provided without suspension components.

In some examples, the tracks of the vehicle assembly are provided with suspension components.

In some examples, each track of the vehicle assembly is supported by bottom wheels. The bottom wheels are provided in pairs, with each pair including two bottom wheels joined together with a bogey board. The bogey board has a central axle that is rotatably mounted to a side of the vehicle assembly, enabling the bogey board and thus the two wheels connected thereto to pivot about the axle.

In some examples, suspension is provided between the axle of a bogey board and the side of the vehicle, e.g., by way of a suspension disk or puck.

In some examples, the vehicle assembly further includes a plow mounted to a front of the vehicle assembly.

In some examples, the vehicle assembly further includes a forklift mounted to the front of the vehicle assembly.

In some examples, the vehicle assembly further includes a combination plow/forklift mounted to the front of the vehicle assembly.

In some examples, the vehicle assembly includes an adapter configured to attach to multiple different heads, the heads including any of (i) a straight blade plow, (ii) a V-plow, (iii) a forklift, and/or (iv) a plow/forklift.

In some examples, the vehicle assembly further includes first and second deployable outriggers placed at an end of the vehicle assembly. The outriggers may be deployed to resist lifting of an opposite end of the vehicle when the crane is carrying heavy items.

In some examples, the outriggers are hydraulically actuated.

In some examples, the crane is attached to the top deck via a rotatable platform (turntable).

In some examples, the rotatable platform is electronically actuated.

In some examples, the rotatable platform is disposed at the same end of the vehicle assembly as the outriggers.

In some examples, the crane includes interchangeable grippers.

In some examples, a gripper of the crane includes a camera configured to visualize the item being gripped.

In some examples, the vehicle assembly includes multiple cameras, including front, rear, left, and/or right cameras, as well as a gripper camera in some examples. Output from the cameras may be viewed by a control station, which may be located remotely from the vehicle assembly.

In some examples, the vehicle assembly includes a wireless interface, such as Wi-Fi and/or Bluetooth, configured to send video and status to a control station and to receive control commands from the control station.

In some examples, the control commands include (i) commands for operating tracks of the vehicle assembly, (ii) commands for operating the crane and gripper, and (iii) commands for operating the deployable outriggers.

In some examples, the vehicle assembly has a sloping back end which facilitates dragging heavy items into the basket from the rear of the vehicle assembly.

In some examples, the sloping back end includes rollers, such as wheels or rotatable dowels, to reduce friction while sliding heavy items into the basket.

In some examples, a plow or other attachment at the front of the vehicle assembly acts as a counterweight when lifting heavy items behind the vehicle assembly using the crane.

In some examples, the vehicle assembly further includes a winch.

In some examples, the vehicle assembly further includes a towing hitch receiver.

In some examples, a gripper of the crane includes a central member and first and second end members. The first and second end members are slidably engaged with the central members. For example, the first and second end members are configured to telescope in and out of the central member.

In some examples, at least one of the first and second end members is coupled to a rack and engages a pinion. The pinion may be rotated in one direction to extend the end member relative to the central member and in an opposite direction to retract the end member further relative to the central member.

Preferably, each of the first and second end members is coupled to an associated rack. In an example, one rack engages with the front of the pinion and the other rack engages with the back. Spinning the rack in one direction (e.g., clockwise) causes the two end members to extend outwardly, and spinning the rack in the opposite direction (e.g., counterclockwise) causes the two end members to retract inwardly.

In some examples, the gripper further includes first and second jaws coupled to the first and second end members, respectively.

In some examples, the jaws are rotatably mounted to the respective end members to allow them to tilt inwardly and/or outwardly under electrical or hydraulic control.

At least some of the above-described features may be provided in the form of a trailer that can be towed behind a vehicle, such as a tracked vehicle. The vehicle may be a firefighting vehicle, such as a tracked firefighting vehicle. The trailer includes a top deck and a crane capable of grasping and lifting burning items and placing them onto the top deck. Items placed in this manner can then be towed to safety by remote control or otherwise.

In some examples, the trailer includes a quick-release coupler for connecting to the vehicle.

In some examples, the trailer is remote-controlled via a common controller configured to control both the trailer and the vehicle.

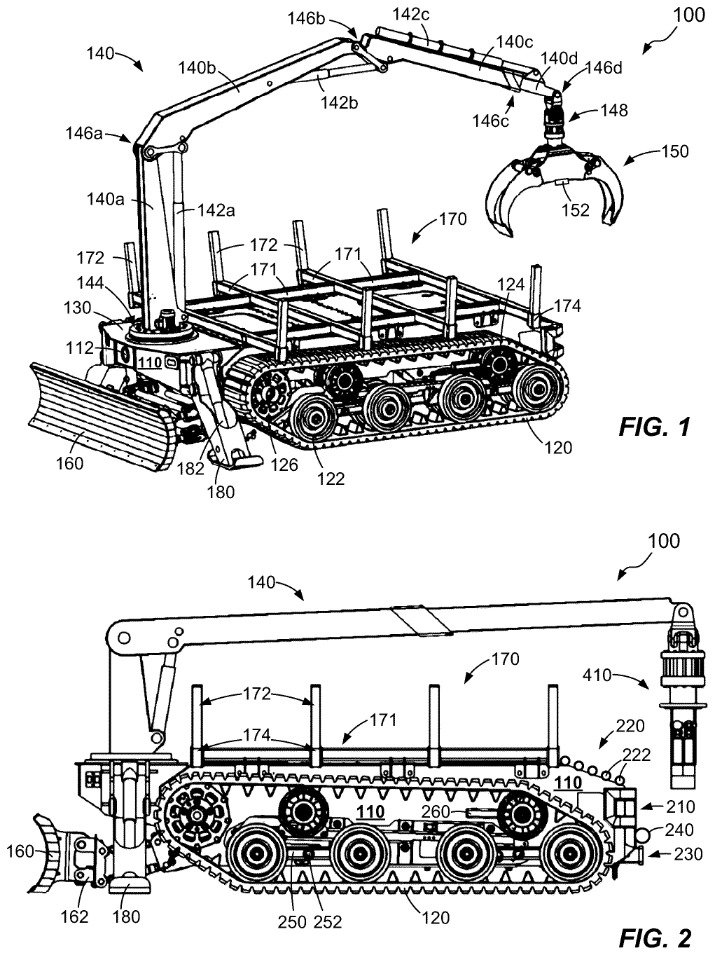

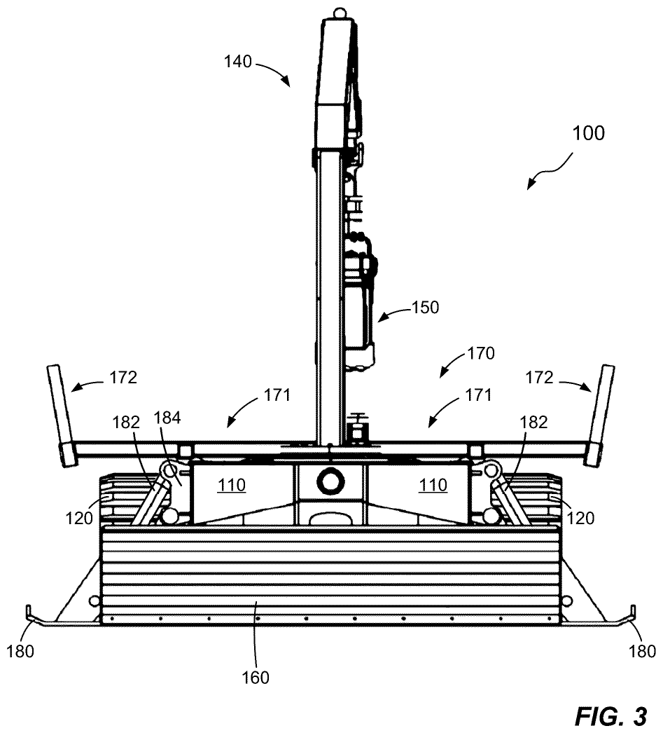

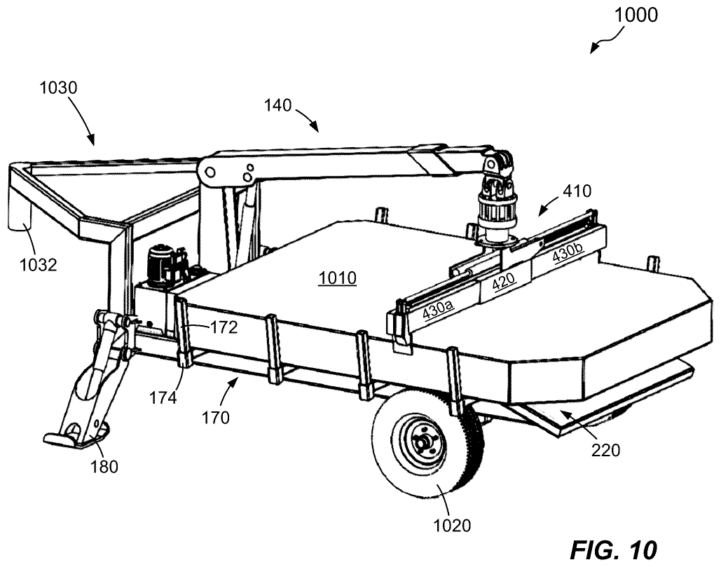

The term “vehicle assembly” as used herein describes both a tracked vehicle and a trailer, as well as a trailer coupled to a tracked vehicle. FIGS. 1-9 show various examples of a tracked vehicle that may be used for carrying hazardous objects. FIG. 10 shows an example trailer that may be used in carrying hazardous objects. The crane of FIGS. 1 and 3 differs from the crane shown in FIGS. 2 and 4-10. Also, the gripper shown in FIGS. 1 and 3 differs from the one shown in FIGS. 2 and 4-10. The various cranes and grippers are shown merely as examples and are not intended to be limiting.

FIG. 1 shows an example tracked vehicle 100 according to one or more embodiments. The tracked vehicle 100 includes a chassis 110, a set of tracks 120, a crane 140, and a basket 170. The tracked vehicle 100 further includes a plow attachment 160 and deployable outriggers 180. In the example shown, the tracked vehicle 100 does not include a nozzle to assist with firefighting. Other examples may include a nozzle, however.

The chassis 110 has a top deck 130, which provides a substantially flat surface for transporting equipment and/or personnel. The set of tracks 120 is coupled with the chassis 110 and includes bottom wheels 122, top wheels 124, and a drive sprocket 126. A rear top wheel 124 is configured as a tensioner wheel. In an example, the drive sprocket 126 is driven by an electric motor via a gearbox (not shown). In some arrangements, video cameras 112 are mounted to the chassis 110 configured to provide video from one or more sides of the tracked vehicle 100.

The basket 170 includes a base 171 affixed to the top deck 130 and multiple receivers 174 for receiving upright members 172. The base 171 is spaced above the top deck 130 for holding hazardous objects a distance above the top deck 130, thereby helping to prevent damage to the top deck 130. The upright members 172 are insertable into the receivers 174. The receivers 174 are disposed on left and right sides of the base and are oriented upwardly and outwardly from the base. In this manner, the basket 170 is wider on top than at the bottom. Alternatively or additionally, a closable, airtight compartment may be provided for storing burning materials, e.g., lithium ion battery packs being transported.

The crane 140 includes arm segments 140a through 140d, hydraulic cylinders 142a through 142c, a turntable 144, joints 146a through 146d, a gripper interface 148, and a gripper 150. The turntable 144 is coupled to the chassis 110 and is rotatable relative to the chassis 110. The first arm segment 140a is coupled to the turntable 144. The first and second arm segments 140a and 140b are coupled together via the hinge joint 146a and may be actuated via the hydraulic cylinder 142a. The second and third arm segments 140b and 140c are coupled together via the hinge joint 146b and may be actuated via the hydraulic cylinder 142b. The third and fourth arm segments 140c and 140d are coupled together via the sliding (telescoping) joint 146c and may be actuated via the hydraulic cylinder 142c. The fourth arm segment 140c and the gripper 150 are coupled together via the wrist joint 146d and the gripper interface 148. The wrist joint 146d may be passive or actuated, such as under hydraulic or electrical control. Similarly, the gripper interface 148 may be passive or rotatable, such as under electrical control.

The gripper 150 is constructed and arranged to grip hazardous objects, such as a burning lithium-ion battery. The gripper 150 may be hydraulically or electrically actuated. In some arrangements, a gripper camera 152 is attached to the gripper 150. The gripper camera 152 is configured to visualize an object being gripped by the gripper 150. Video from the gripper camera 152 may be provided to a remote-control station for controlling the tracked vehicle 100.

The head attachment 160 is coupled to a front of the vehicle chassis 110. The head attachment 160 may be provided as a plow attachment, a forklift attachment, or a combination plow-forklift attachment. The plow attachment may be a straight plow or a V-plow.

The deployable outriggers 180 are disposed on left and right sides of the vehicle chassis 110 and include hydraulic cylinders 182 for lowering and lifting the deployable outriggers 180. The deployable outriggers 180 are provided at a front end of the vehicle chassis 110, i.e., the same end as the crane 140. The deployable outriggers 180 are constructed and arranged to resisting lifting of a second end of the vehicle, opposite the first end, e.g., while the crane 140 holds an object in front of the vehicle or to the sides.

During example operation, the tracked vehicle 100 is driven to a location of a hazardous object, such as a burning lithium-ion battery. The crane 140 is operated to lift the hazardous object and place the hazardous object into the basket 170. The tracked vehicle 100 may then be driven to transport the hazardous object to a safe location. In some arrangements, driving the tracked vehicle 100 and operating the crane 140 are performed based on receiving control commands from a remote controller.

FIG. 2 shows the example tracked vehicle 100 having an alternative crane arrangement and an alternative second end (back portion) according to one or more embodiments. FIG. 2 further shows additional details of the head attachment 160 and the set of tracks 120 described above in regards to FIG. 1.

As shown in FIG. 2, the crane 140 is provided as a telescoping boom and includes a gripper 410 that differs from the gripper 150 (FIG. 1). Details of the gripper 410 will be explained in greater detail below.

The back portion includes a rear bumper 210, a sloping rear surface 220, a towing hitch receiver 230, and a winch attachment 240. The sloping rear surface 220 extends downward from top deck 130 and is constructed and arranged to enable the crane 140 to pull objects into the basket 170. A set of rollers 222, such as wheels, dowels, or the like, is coupled to the sloping rear surface 220 and serves to reduce friction as the crane 140 pulls objects into the basket 170 from the back end of the vehicle 100. For example, the rollers 222 enable objects to be rolled, rather than dragged, into the basket 170.

According to one or more embodiments, the head attachment 160 is coupled to the vehicle chassis 110 via a quick-change interface 162. In some arrangements, the quick-change interface 162 enables a variety of head attachments 160 to be attached to the vehicle chassis 110, such as a plow attachment, a forklift attachment, or a combination plow-forklift attachment.

The vehicle further includes bogey boards 250 and a tensioning mechanism 260. Each of the bogey boards 250 connects two adjacent bottom wheels 122 and is rotatably coupled to the vehicle chassis 110 via a respective pivot 252, either with or without suspension. The tensioning mechanism 260 is constructed and arranged to advance and retract the rear top wheel 124.

FIG. 3 shows a front view of the example tracked vehicle 100 of FIG. 1. As shown in FIG. 3, the deployable outriggers 180 are coupled to the vehicle chassis 110 via respective brackets 184.

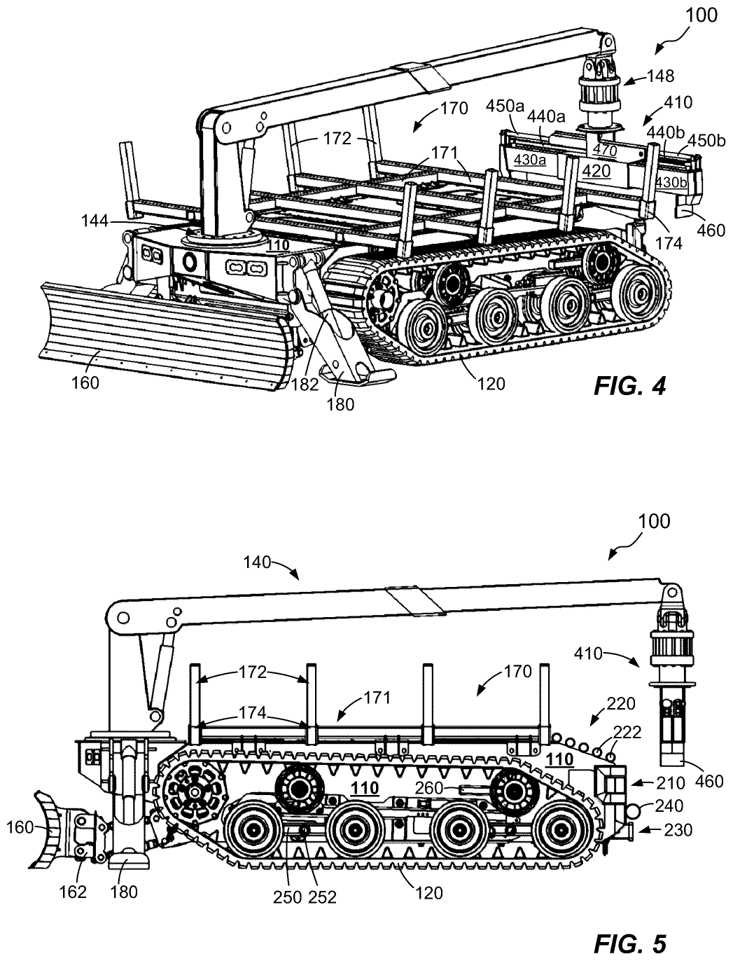

FIGS. 4 through 9 show various views of the example tracked vehicle 100 as provided in FIG. 2. The tracked vehicle 100 includes the gripper 410, which has a central housing 420, sliding members 430a and 430b, jaws 460, and an adapter 470. In some arrangements, the gripper 410 is interchangeable with the gripper 150 (FIG. 1).

As best shown in FIG. 4, the sliding members 430a and 430b are configured to slide in and out of central housing 420 for laterally gripping an object to be carried via the jaws 460. One of the sliding members 430a and 430b may be configured to telescope within the other, to enable the jaws 460 to directly contact each other in a fully closed condition.

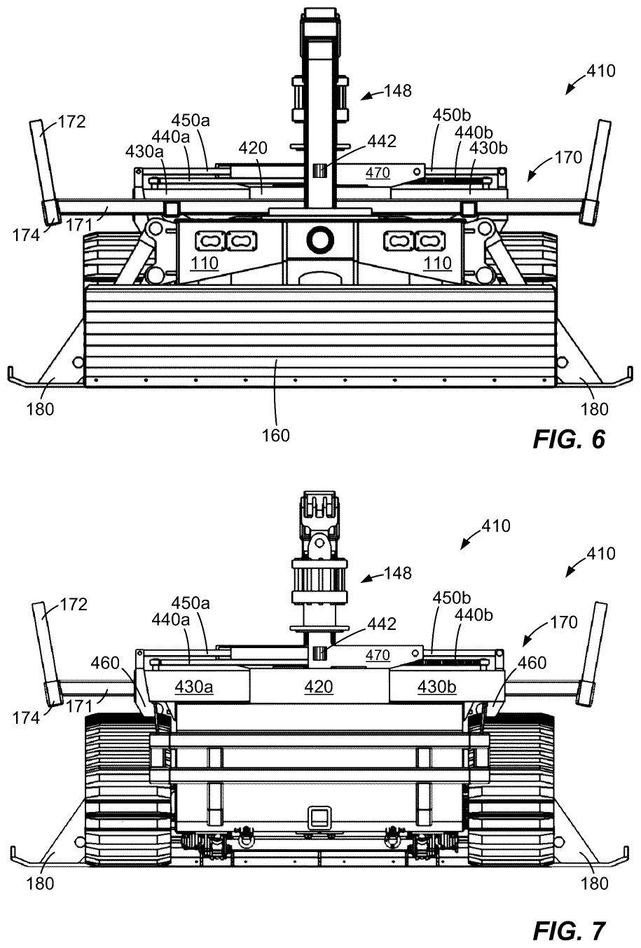

The sliding members 430a and 430b include respective racks 440a and 440b, and respective guide rods 450a and 450b. The racks 440a and 440b are constructed and arranged to engage with a central pinion 442 (FIGS. 6 and 7) for advancing and retracting the sliding members 430a and 430b, thereby opening and closing the jaws 460. The guide rods 450a and 450b provide support for advancing and retracting the sliding members 430a and 430b.

The adapter 470 includes the central pinion 442 and is constructed and arranged to attach to the gripper interface 148 of the crane 140. The central pinion 442 is shown schematically in FIGS. 6 and 7, although the central pinion 442 is internal to the adapter 470 and thus hidden from view. The racks 440a and 440b engage the pinion 442 on both front and back, such that rotation of the central pinion 442 in one direction opens the jaws 460 and rotation of pinion in the opposite direction closes the jaws 460.

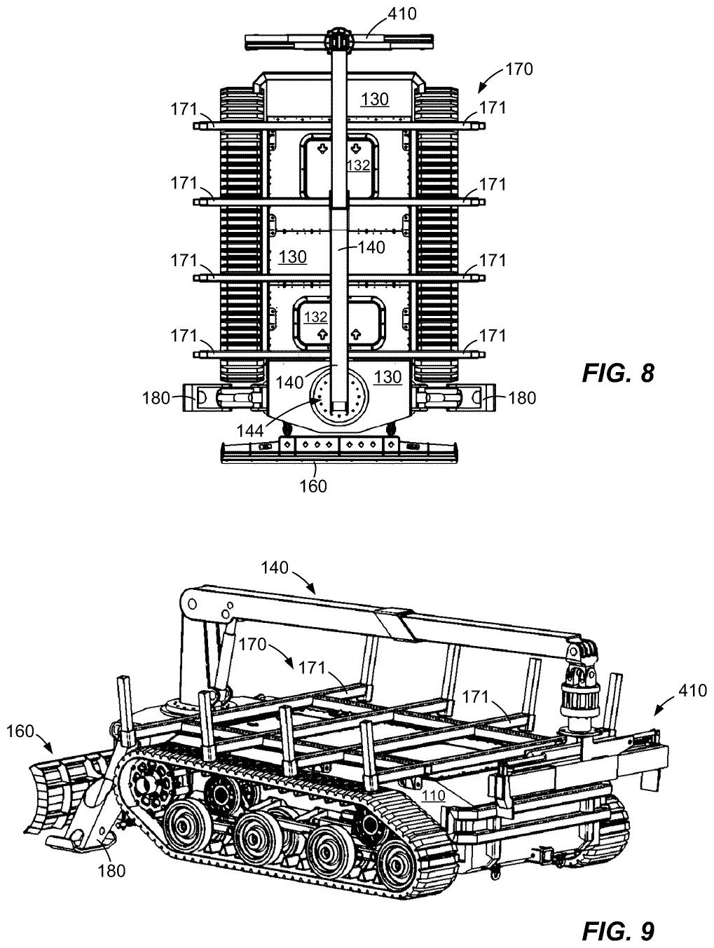

As shown in FIGS. 8 and 9, the base 171 of the basket 170 includes multiple axial and transverse members, forming an open frame. Closed frame designs may alternatively be used, however. Spaces between the axial and transverse members provide access to the top deck 130. The top deck 130 includes access ports 132 disposed between the axial and transverse members. In this manner, the access ports 132 may be accessed without removing the basket 170.

During example operation, the gripper 410 may be positioned over a hazardous object, e.g., a burning lithium-ion battery. Once in position, the sliding members 430a and 430b may be retracted to close the jaws 460 around the hazardous object based on rotation of the central pinion 442. The crane 140 may then lift the hazardous object and place the hazardous object in the basket 170. The tracked vehicle 100 may then be driven to a safe location.

FIG. 10 shows an example trailer 1000, which forms a vehicle assembly according to one or more embodiments. The trailer 1000 includes features described above in relation to the example tracked vehicle 100 (FIGS. 1 through 9), such as the crane 140, the basket 170, the deployable outriggers 180, the sloping back surface 220, and the gripper 410. The trailer 1000 further includes wheels 1020 and a towing adapter 1030, which includes a gooseneck coupler 1032 for quick release. As illustrated, the trailer 1000 carries an example object 1010, such as a lithium-ion battery.

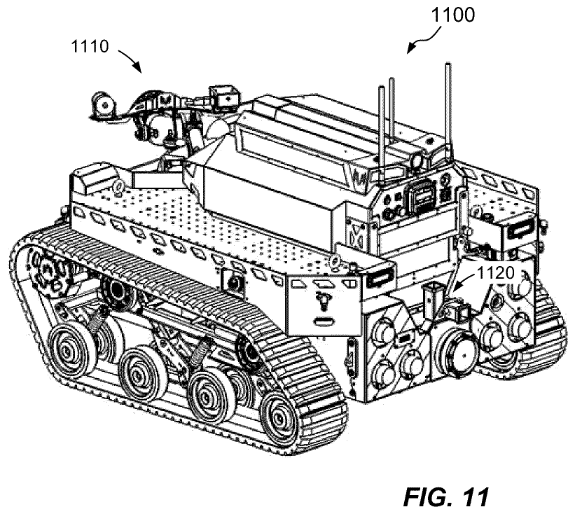

FIG. 11 shows an example firefighting vehicle 1100, which may be used with the trailer 1000 of FIG. 10 according to one or more embodiments. The firefighting vehicle 1100 includes a nozzle 1110 and a towing hitch receiver 1120. The nozzle 1110 is constructed and arranged to discharge firefighting fluid. The towing hitch receiver 1120 is constructed and arranged to engage the towing adapter 1030 of the trailer 1000 (FIG. 10). In some arrangements, the firefighting vehicle 1100 and the trailer 1000 are controlled via a common remote controller. For example, the remote controller may provide control commands for driving the firefighting vehicle 1100 as well as for operating the crane 140 and the outriggers 180 of the trailer 1000.

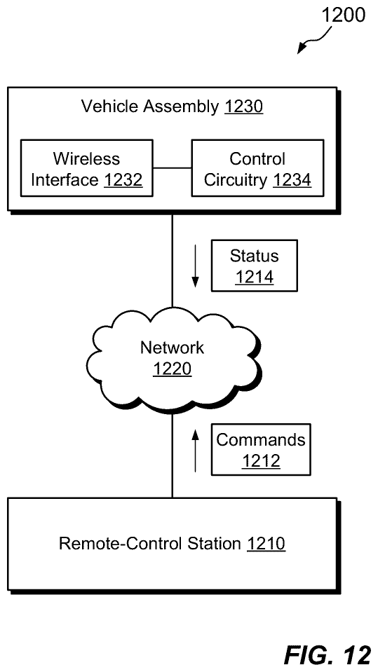

FIG. 12 is a block diagram of a remote-control system 1200 according to one or more embodiments. As shown, the vehicle assembly 1230 is communicatively coupled to a remote-control station 1210 over a network 1220, such as a wireless network. Examples of the vehicle assembly 1230 include the tracked vehicle 100 (FIGS. 1-9), the trailer 1000 (FIG. 10), and a combination of the firefighting vehicle 1100 (FIG. 1) coupled with the trailer 1000.

The vehicle assembly 1230 includes a wireless interface 1232 and control circuitry 1234. The wireless interface 1230 is constructed and arranged to receive control commands 1212 from the remote-control station 1210 and provide status information 1214 to the remote-control station 1210. The control circuitry 1234 is coupled to the wireless interface 1232 and is constructed and arranged to operate the vehicle assembly 1230 based on the control commands 1212. For example, in response to receiving the control commands 1212, the control circuitry 1234 may drive the vehicle assembly 1230, deploy the outriggers 180, operate the crane 140, and so forth.

In some arrangements, the status information 1214 includes video from the gripper camera 152 and/or the chassis cameras 112. In this manner, the video may be viewed remotely from the tracked vehicle 100, away from the hazardous environment.

### Example Aspects of the Vehicle

The depicted embodiments described above are meant to enhance and diversify the resources available to a firefighter. The depicted tracked vehicle and trailer serve two main purposes, 1) to quickly respond to potential thermal events caused by lithium batteries or other hazardous items and remove the cause from the manufacturing/assembly floor, and 2) provide a modular platform for outfitting gear, attachments, tools, and other relevant firefighting items. The remote operated boom arm allows the operator to remove the unsafe item the floor, assembly line, etc., all while from a safe distance. Several other features provide additional tooling in the form of a winch, hitch, scene lighting, and cameras for situational awareness.

In embodiments that include a tracked vehicle, an aluminum or steel chassis hull contains a fully electric drivetrain and battery bank for powering the vehicle. Bolted to the chassis hull is a track suspension system (with capability to be sprung or unsprung) complete with drive sprockets, road wheels, and a tensioner wheel. The hull is covered by a cargo area and grapple arm. The basket acts as a storage place for anything picked up by the grapple arm. The cargo area can include either an open basket design or a fire rated enclosure to help mitigate facility damage, for example. A receiver hitch located on the rear of the machine accepts a hitch for moving trailers, a removeable winch can also be pinned to the hitch. The winch plugs into a port in the back of the vehicle for power supply.

Particularly noteworthy features include but are not limited to the following:
Boom arm to easily pick up items in all sorts of positions
Interchangeable head attachments on boom for different lift cases
Outriggers for stability when lifting
Plow for debris clearing
Quick change head for other attachments
Open rack or fire rated enclosure for hazard removal

The depicted embodiments are expected to find applications in battery manufacturing, petroleum plants, warehouses, airports, power plants, and military bases, for example. However, the disclosed vehicle can be used in any industry looking to remove potentially exothermic batteries or debris from a facility, or in any situation in which there is a need for standoff distance from a potentially dangerous situation and with a need to remove the dangerous situation from the building/area.

Having described certain embodiments, numerous alternative embodiments or variations can be made. For example, although embodiments have been described for use with vehicles having electric drivetrains, embodiments may also be realized with vehicles having other types of drivetrains, such as gasoline or diesel drivetrains.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the disclosure.

The following table of reference characters points out specific features of the drawings and their relationship to the features described herein (description continues below table):

Table of Reference Numerals

| Reference | |
|---|---|
| Numeral | Description |
| 100 | Tracked vehicle |
| 110 | Chassis |
| 112 | Chassis camera |
| 120 | Track |
| 122 | Bottom wheels (x4) |
| 124 | Top wheels (x2); rear top wheel may be a tensioner wheel |
| 126 | Drive sprocket, driven by an electric motor via a gearbox |
| 130 | Top deck (e.g., flat, for transporting equipment and/or personnel). |
| 132 | Access ports, e.g., located between floor members of basket to |
| | provide access without removing basket. |
| 140 | Crane (controllable for left-right rotation, and for articulation via |
| | joints. |
| 140a, 140b, | First, second, third, and fourth arm segments of crane. Fourth |
| 140c, 140d | segments telescopes within third segment. |
| 142a, 142b, 142c | First, second, and third hydraulic cylinders. |
| 144 | Turntable allowing rotation relative to vehicle chassis |
| 146a, 146b | First and second hinge joints |
| 146c | Sliding (telescoping) joint |
| 146d | Wrist joint. May be passive or actuated under hydraulic or electrical |
| | control. |
| 148 | Interface to gripper. May be passive or rotatable under electrical |
| | control. |
| 150 | Gripper. May be hydraulically or electrically actuated. |
| 152 | Gripper camera, configured to visualize item being gripped. |
| 160 | Plow attachment (alternatively, may be used with forklift attachment |
| | or combination plow/forklift attachment). |
| 162 | Quick-change interface; e.g., for enabling fast changes of plow head, |
| | forklift head, etc.). |
| 170 | Basket; for carrying batteries or other cargo, which may be on fire. |
| | Alternatively or additionally, a closable, airtight compartment may be |
| | provided for storing burning materials, e.g., lithium ion battery packs |
| | being transported. |
| 171 | Base of basket |
| 172 | Uprights/retainers, e.g., for containing cargo and keeping cargo from |
| | slipping out of basket |
| 174 | Receiver, for allowing uprights to be replaced with others of the same |
| | or different shape or length. |
| 180 | Deployable outrigger (x2) |
| 182 | Hydraulic cylinder (x2) for lowering and lifting outriggers |
| 184 | Bracket (x2), e.g., for attaching outrigger to chassis |
| 210 | Rear bumper |
| 220 | Sloping rear surface (e.g., for aiding in pulling heavy battery packs |
| | into basket) |
| 222 | Optional rollers (e.g., for aiding in pulling heavy battery packs into |
| | basket) |
| 230 | Towing hitch receiver |
| 240 | Optional winch attachment |
| 250 | Bogey board (x2); connects two adjacent bottom wheels |
| 252 | Pivot for bogey board; e.g., attaches to side of chassis 110, either |
| | directly (no suspension) or via suspension puck or other mechanism |
| | (with suspension). |
| 260 | Tensioning mechanism (e.g., for advancing and retracting rear top |
| | wheel) |
| 410 | Alternative Gripper. May be hydraulically or electrically actuated. |
| | May be interchangeable with gripper 150. |
| 420 | Central housing |
| 430a, 430b | First and second sliding/telescoping members, e.g., configured to slide |
| | in and out of housing 420 for laterally gripping item to be carried. One |
| | of the members may be configured to telescope within the other, to |
| | enable jaws to directly contact each other in fully closed condition |
| 440a, 440b | First and second racks, for engaging with a central pinion for |
| | symmetrically advancing and retracting first and second members, |
| | thereby tending to open and close jaws. |
| 442 | Pinion (shown schematically, as is internal to adapter 470 and thus |
| | hidden from view. Racks engage pinion on both front and back, such |
| | that rotation of pinion in one direction opens jaws and rotation of |
| | pinion in the other direction closes jaws. |
| 450a, 450b | First and second guide rods |
| 460 | Jaws, e.g., for applying lateral force to object being carried. Jaws may |
| | be hinged to tilt inwardly or outwardly for accommodating different |
| | gripping arrangements. |
| 470 | Adapter for attaching gripper 410 to interface |
| 1000 | Example trailer |
| 1010 | Item being carried, e.g., lithium ion battery module |
| 1020 | Wheels (x2); alternatively or additionally, tracks may be provided. |
| 1030 | Towing adapter |
| 1032 | Gooseneck coupler, e.g., quick release. |
| 1100 | Firefighting vehicle |
| 1110 | Nozzle |
| 1120 | Towing hitch adapter |
| 1200 | Block diagram of a remote-control arrangement for controlling the |
| | vehicle assembly. |
| 1210 | Remote-control station |
| 1212 | Control commands for controlling the vehicle assembly |
| 1214 | Status information, e.g., video feed from camera |
| 1220 | Network, e.g., wireless network |
| 1230 | Vehicle assembly |
| 1232 | Wireless interface |
| 1234 | Control circuitry |

What is claimed is:

1. A vehicle assembly, comprising:
a vehicle body having a top deck;
a basket affixed to the top deck; and
a crane coupled to the vehicle body, the crane constructed and arranged to lift a hazardous object and place the hazardous object into the basket.

2. The vehicle assembly of claim 1, wherein the basket includes a base spaced above the top deck, the base constructed and arranged to hold the hazardous object a distance away from the top deck.

3. The vehicle assembly of claim 2, wherein the base includes multiple receivers on left and right sides of the base, the receivers oriented upwardly and outwardly relative to the base, and wherein the basket further includes multiple side members that slidably engage with the receivers on the left and right sides of the base.

4. The vehicle assembly of claim 1, further comprising:
a wireless interface constructed and arranged to receive control commands from a remote-control station; and
control circuitry coupled to the wireless interface, the control circuitry constructed and arranged to operate the crane based on the control commands.

5. The vehicle assembly of claim 1, further comprising a video camera coupled to the crane.

6. The vehicle assembly of claim 1, wherein the vehicle body is part of a tracked vehicle.

7. The vehicle assembly of claim 1, wherein the tracked vehicle attaches to at least one of: (i) a straight-blade plow, (ii) a V-plow, or (iv) a plow-forklift attachment.

8. The vehicle assembly of claim 1, wherein the vehicle body is part of a trailer having a towing adapter.

9. The vehicle assembly of claim 8, further comprising:
a tracked vehicle including a towing hitch receiver constructed and arranged to engage with the towing adapter of the trailer; and
control circuitry constructed and arranged to operate both the crane and the tracked vehicle.

10. The vehicle assembly of claim 9, wherein the tracked vehicle is a firefighting vehicle having a nozzle constructed and arranged to discharge firefighting fluid.

11. The vehicle assembly of claim 1,
wherein the vehicle body has a first end and a second end opposite the first end, wherein the crane is coupled to the vehicle body at the first end, and
wherein the vehicle assembly further comprises first and second outriggers coupled to the vehicle body at the first end, the first and second outriggers constructed and arranged to resist lifting of the second end.

12. The vehicle assembly of claim 1, wherein the crane is coupled to the vehicle body via a rotatable platform.

13. The vehicle assembly of claim 1, wherein the crane includes a gripper constructed and arranged to grasp the hazardous object.

14. The vehicle assembly of claim 13, wherein the gripper includes:
a central member; and
first and second end members constructed and arranged to grasp the hazardous object via respective jaws, at least one of the first and second end members slidably engaged with the central member.

15. The vehicle assembly of claim 1,
wherein the vehicle body further includes a sloping back portion extending downwards from the top deck, the sloping back portion constructed and arranged to support the hazardous object as the crane pulls the hazardous object into the basket.

16. The vehicle assembly of claim 15, wherein the sloping back portion includes a set of rollers constructed and arranged to reduce friction as the crane pulls the hazardous object into the basket.

17. A remote-controlled firefighting vehicle, comprising:
a vehicle body having a top deck;
a basket affixed to the top deck;
a crane coupled to the vehicle body at a first end of the vehicle body, the crane constructed and arranged to lift a hazardous object and place the hazardous object into the basket;
first and second outriggers coupled to the first end, the first and second outriggers constructed and arranged to resist lifting of a second end of the vehicle body; and
control circuitry constructed and arranged to drive the firefighting vehicle, operate the first and second outriggers, and operate the crane based on control commands received from a remote controller.

18. A method of operating a vehicle assembly, the method comprising:
based on receiving a first set of control commands from a remote controller, driving the vehicle assembly a location of a hazardous object, the vehicle assembly including (i) a vehicle body having a top deck and (ii) a basket being affixed to the top deck;
based on receiving a second set of control commands from the remote controller, operating a crane coupled to the vehicle body to lift the hazardous object and place the hazardous object into the basket; and
based on receiving a third set of control commands from the remote controller, driving the vehicle assembly to transport the hazardous object.
